(19) United States
(12) Patent Application Publication
(10) Pub. No.: US 2021/0088824 A1
(43) Pub. Date: Mar. 25, 2021

(54) DISPLAY DEVICE AND TOUCH DISPLAY DEVICE

(71) Applicant: Innolux Corporation, Miao-Li County (TW)

(72) Inventors: Chia-Hao Tsai, Miao-Li County (TW); Yi-Shiuan Cherng, Miao-Li County (TW); Yung-Hsun Wu, Miao-Li County (TW)

(73) Assignee: Innolux Corporation, Miao-Li County (TW)

(21) Appl. No.: 17/000,378

(22) Filed: Aug. 24, 2020

(30) Foreign Application Priority Data
Sep. 19, 2019 (CN) 201910888453.5

(51) Int. Cl. G02F 1/1333; G02F 1/1368; G02F 1/1362; G02F 1/1343; G02F 1/1335; G06F 3/041; G09G 3/36; G09G 3/20

(52) U.S. Cl. CPC G02F 1/13338; G09G 2300/0426; G02F 1/136286; G02F 1/134363; G02F 1/133512; G02F 1/133514; G06F 3/0412; G09G 3/3648; G09G 3/3674; G09G 3/3685; G09G 3/2003; G02F 2001/13685; G02F 2201/121; G02F 2201/123; G02F 1/1368

(57) ABSTRACT

A display device and a touch display device are provided. The display device includes a first data line, a second data line, a first pixel electrode, a second pixel electrode, a first signal line, and a first functional electrode. The first pixel electrode is electrically connected to the first data line, and the first pixel electrode corresponds to a first color. The second pixel electrode is electrically connected to the second data line, and the second pixel electrode corresponds to the first color. The first signal line is disposed between the first pixel electrode and the second pixel electrode. The first functional electrode is electrically connected to the first signal line.

### CROSS-REFERENCE TO RELATED APPLICATION

This application claims the priority benefit of Chinese patent application serial no. 201910888453.5, filed on Sep. 19, 2019. The entirety of the above-mentioned patent application is hereby incorporated by reference herein and made a part of this specification.

### BACKGROUND OF THE DISCLOSURE

### 1. Field of the Disclosure

The disclosure relates to an electronic device, and particularly to a display device and a touch display device.

### 2. Description of Related Art

A display device may provide a touch function by being provided with a touch element (such as a signal line and/or a functional electrode). The cost is increased when the touch element is provided by increasing process steps and the number of masks. On the other hand, during integration of process steps of the touch element with original process steps of the display device, for example, simultaneous fabrication of the signal line and a metal layer in the display device, a coverage area of a shielding layer needs to be expanded to shield the signal line, resulting in reduction of an aperture ratio.

### SUMMARY OF THE DISCLOSURE

A display device and a touch display device are provided in the disclosure, which helps to alleviate the problem of reduction of the aperture ratio or the cost.

According to an embodiment of the disclosure, the display device includes a first data line, a second data line, a first pixel electrode, a second pixel electrode, a first signal line, and a first functional electrode. The first pixel electrode is electrically connected to the first data line, and the first pixel electrode corresponds to a first color. The second pixel electrode is electrically connected to the second data line, and the second pixel electrode corresponds to a first color. The first signal line is disposed between the first pixel electrode and the second pixel electrode. The first functional electrode is electrically connected to the first signal line.

According to an embodiment of the disclosure, the touch display device includes a first data line, a second data line, a first pixel electrode, a second pixel electrode, a signal line, and a functional electrode. The first pixel electrode is electrically connected to the first data line. The second pixel electrode is electrically connected to the second data line. The second pixel electrode is adjacent to the first pixel electrode, and a gap is provided between the first pixel electrode and the second pixel electrode. The signal line is disposed corresponding to the gap. The functional electrode is electrically connected to the signal line.

Based on the above, in the embodiments of the disclosure, the problem of reduction of the aperture ration is alleviated by disposing the first signal line between the first pixel electrode and the second pixel electrode. In an embodiment, the first data line, the second data line, and the first signal line may be formed by the same layer, so as to reduce the cost.

In order to make the above features and advantages of the disclosure comprehensible, embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic partial cross-sectional view of a display device according to a first embodiment of the disclosure.

FIG. 2 is a schematic partial top view of the display device according to the first embodiment of the disclosure.

FIG. 3 is a schematic partial top view of a signal line and a functional electrode in the display device according to the disclosure.

FIG. 4 to FIG. 6 are schematic partial top views of a display device according to a second embodiment of the disclosure to a display device according to a fourth embodiment respectively.

### DESCRIPTION OF THE EMBODIMENTS

The disclosure may be understood with reference to the following detailed description and the accompanying drawings. It should be noted that, for ease of understanding by readers and concise drawings, a plurality of drawings in the disclosure merely show a part of an electronic device/a display device, and specific components in the drawings are not drawn to scale. In the accompanying drawings, common features of a method, a structure, and/or a material used in a specific embodiment are shown in the drawings. However, these drawings should not be construed as defining or limiting the scope or nature of these embodiments. For example, relative sizes, thicknesses, and positions of films, regions, and/or structures may be reduced or enlarged for clarity.

Some words are used to refer to specific elements in the whole specification and the appended claims in the disclosure. A person skilled in the art should understand that an electronic device manufacturer may use different names to refer to same elements. This specification is not intended to distinguish elements that have same functions but different names. In this specification and the claims, words such as “have” and “include/comprise” are open words, and should be interpreted as “including, but not limited to”.

The directional terms mentioned herein, such as “above” “below” “front” “back” “left” and “right” refer to the directions in the accompanying drawings. Therefore, the directional terms are only used for illustration instead of limiting the disclosure. It should be understood that, when an element or a film is referred to as being “on” another element or film or “connected to” another element or film, the element or film may be directly on the another element or film or directly connected to the another element or film, or there are elements or films inserted between the two elements or films (indirectly). On the contrary, when an element or a film is referred to as being “directly” “on” another element or film or “directly connected to” another element or film, there is no element or film inserted between the two elements or films.

When an element or a film referred herein is “adjacent to” another element or film, it means that there is no element or film between the two elements or two films.

“Light” and “ray” mentioned herein may be identical in meaning.

“Electrically connected to” and “couple to” mentioned herein may mean that an element or a film is “directly connected to” another element or film to transmit an electric signal, or the two elements or films are “indirectly connected” through other intermediate elements or films.

In the following embodiments, same or similar reference numerals are used to indicate same or similar elements, and details may be omitted in the description. In addition, features in different embodiments may be arbitrarily mixed and matched as long as they do not depart from the spirit of disclosure or conflict with each other, and simple equivalent changes and modifications made according to the specification or claims still fall within the scope of the disclosure. Besides, the terms “first” “second” and the like mentioned in the specification or the claims are used only to name discrete elements or to distinguish different embodiments or ranges, but are not intended to define the upper or lower limit of the number of elements or the manufacturing or arrangement order of the elements.

The display device of the disclosure may be any kind of display device, such as a self-luminous display device or a non-self-luminous display device. The self-luminous display device may include a light-emitting diode, a color conversion layer, or other appropriate materials, or a combination of the above, but the disclosure is not limited thereto. The light-emitting diode may include, for example, an organic light emitting diode (OLED), a mini LED, a micro LED, or a quantum dot LED (which may include a QLED and a QDLED), but the disclosure is not limited thereto. The color conversion layer may include a wavelength conversion material and/or a light filtering material. The color conversion layer may include, for example, fluorescence, phosphor, a quantum dot (QD), other appropriate materials, or a combination of the above, but the disclosure is not limited thereto. The non-self-luminous display device may include a liquid crystal display device, but the disclosure is not limited thereto. Content of the disclosure is described below by taking a liquid crystal display device as the display device, but the disclosure is not limited thereto.

The display device of the disclosure may provide a touch function to become a touch display device by being provided with a touch element, for example, a scan line, a signal line, a read-out line, an amplifier, an integrator, a sensor and/or a sensing electrode, a touch controller and/or a touch arithmetic unit. The sensor may be configured to detect physical quantities such as light (visible, infrared, or ultraviolet light), heat, electricity (resistance, capacitance, or inductance), force (pressure or gravity), sound wave (ultrasonic wave), and so on. A functional electrode is applicable to capacitance sensing such as surface capacitance, self projected capacitance, mutual projected capacitance, and so on, or belongs to one of the above sensor structures. A relative structural relationship between the sensing electrode or sensor and a display structure may be out cell, on-cell or in cell. Content of the disclosure is described below with an in-cell self projected-capacitance touch display device, but the disclosure is not limited thereto.

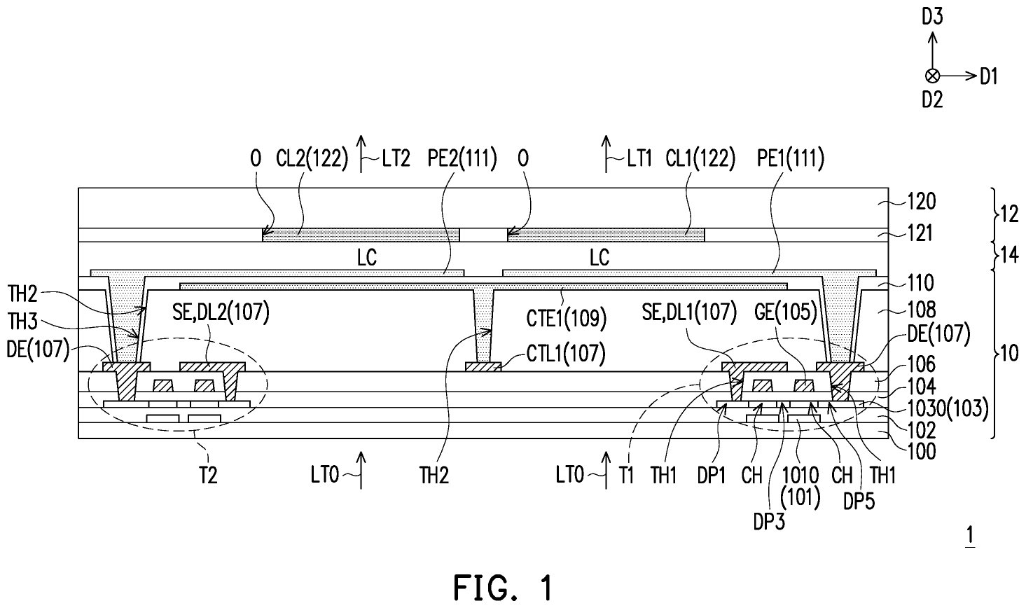

FIG. 1 is a schematic partial cross-sectional view of a display device 1 according to a first embodiment of the disclosure. Referring to FIG. 1, the display device 1 may include a first data line DL1, a second data line DL2, a first pixel electrode PE1, a first color conversion layer CL1, a second pixel electrode PE2, a second color conversion layer CL2, a first signal line CTL1, and a first functional electrode CTE1. In the embodiment, the first functional electrode CTE1 may be used as a common electrode in a display mode, and used as a touch sensing electrode in a touch mode. In other applications of other embodiments, the first functional electrode CTE1 may be an anode or a cathode, a grounding electrode, a shielding electrode, or the like of a sensor, but the disclosure is not limited thereto. In the embodiment, the first signal line CTL1 transmits a common voltage signal in a display mode, and transmits a touch sensing signal in a touch mode. In other embodiments, the first signal line CTL1 may also transmit a reset signal and other signals in other modes, and the disclosure is not limited thereto.

The first pixel electrode PE1 is electrically connected to the first data line DL1 through an active element T1. The first pixel electrode PE1 corresponds to a color, that is, light in a color is correspondingly emitted from a pixel region of the first pixel electrode PE1. For example, the pixel region may optionally include a first color conversion layer CL1 disposed corresponding to the first pixel electrode PE1 and adapted to allow a light to pass through and produce a spectrum conversion or change, thus achieving an effect of adjusting a light color or light brightness. In an embodiment of a display including a backlight module (not shown), the backlight module provides original light LT0. After the original light LT0 passes through a liquid crystal layer LC and the first color conversion layer CL1 that correspond to the first pixel electrode PE1, first light LT1 may be produced (the first light may be final output light emitted by a pixel corresponding to the first color conversion layer CL1, which is received by an observer along a thickness direction D3 at a light output side of the display device 1, and thus influences of other layers between the observer and the first color conversion layer CL1 are included). The first light LT1 is in a first color. The first color may be, for example, red, green, blue, yellow or white, but the disclosure is not limited thereto.

The second pixel electrode PE2 is electrically connected to the second data line DL2 through an active element T2. The second pixel electrode PE2 is adjacent to the first pixel electrode PE1. The so-called the second pixel electrode PE2 being adjacent to the first pixel electrode PE1 means that no other pixel electrodes are provided between the second pixel electrode PE2 and the first pixel electrode PE1. The second pixel electrode PE2 corresponds to a color, that is, light in a color is correspondingly emitted from a pixel region of the second pixel electrode PE2. For example, the pixel region may optionally include a second color conversion layer CL2 disposed corresponding to the second pixel electrode PE2 and adapted to allow a light to pass through and produce a spectrum conversion or change, thus achieving an effect of adjusting a light color or light brightness. In an embodiment of a display including a backlight module (not shown), the backlight module provides original light LT0. After the original light LT0 passes through a liquid crystal layer LC and the second color conversion layer CL2 that correspond to the second pixel electrode PE2, second light LT2 may be produced (the second light may be final output light emitted by a pixel corresponding to the second color conversion layer CL2, which is received by an observer along a thickness direction D3 at a light output side of the display device 1, and thus influences of other layers between the observer and the second color conversion layer CL2 are included). The second light LT2 is in the same first color as the first light LT1. In other embodiments, the color of the second light LT2 is different from that of the first light LT1, or they are in the same color but have different brightness.

In other embodiments, the display device 1 may not include the first color conversion layer CL1 or the second color conversion layer CL2, or the first color conversion layer CL1 or the second color conversion layer CL2 is made of a transparent material, and a display color may be provided by a light source module or in other manners. In the embodiment, the first color conversion layer CL1 and the second color conversion layer CL2 may include a color filter. In other embodiments, the first color conversion layer CL1 and the second color conversion layer CL2 may include a quantum dot material, a fluorescence material, or a phosphor material, but the disclosure is not limited thereto.

In the embodiment, a shielding layer 121 (block matrix, BM) may be provided between the first color conversion layer CL1 and the second color conversion layer CL2. The shielding layer 121 may overlap with the first signal line CTL1, the active element T1, or the active element T2 in the thickness direction D3.

The first signal line CTL1 is disposed between the first pixel electrode PE1 and the second pixel electrode PE2, and the first signal line CTL1 is in the same layer as the first data line DL1 and the second data line DL2 and is disposed corresponding to a gap between the first pixel electrode PE1 and the second pixel electrode PE2. The first functional electrode CTE1 is electrically connected to the first data line CTL1, and overlaps with the gap between the first pixel electrode PE1 and the second pixel electrode PE2. The first functional electrode CTE1 may at least partially overlap with the first pixel electrode PE1, or at least partially overlap with the second pixel electrode PE2. In other embodiments of the first color conversion layer CL1 and the second color conversion layer CL2, the first color conversion layer CL1 may be optionally disposed between the first pixel electrode PE1 and the liquid crystal layer LC, and the second color conversion layer CL2 may be optionally disposed between the second pixel electrode PE2 and the crystal layer LC, that is, they are disposed on a lower substrate side rather than on an upper substrate side.

In other embodiments, a position of the first functional electrode CTE1 may be optionally changed up and down with the first pixel electrode PE1 and/or the second pixel electrode PE2 (for example, the first functional electrode CTE1 may be closer to the liquid crystal layer LC), that is, the first functional electrode CTE1 is disposed above the first pixel electrode PE1 and the second pixel electrode PE2. In other embodiments, the first data line DL1 may be optionally on a right side of the active element T1, and a junction between the first pixel electrode PE1 and the active element T1 may be optionally on a left side of the active element T1; while the second data line DL2 may be optionally on a left side of the active element T2, and a junction between the second pixel electrode PE2 and the active element T2 may be optionally on a right side of the active element T2. In other embodiments, the first color conversion layer CL1 may optionally overlap with the first signal line CTL1, the active element T1, or the active element T2 in the thickness direction D3. In other embodiments, the first signal line CTL1 may be optionally in different layers with the first data line DL1 and the second data line DL2. For example, the first signal line CTL1 may be in the same layer as the first pixel electrode PE1 and the second pixel electrode PE2 or in the same layer as other electrode layers of the active element T1 or the active element T2, but the disclosure is not limited thereto.

In detail, by taking a liquid crystal display device as an example, the display device 1 may include an active element array substrate 10, an opposite substrate 12, and a liquid crystal layer 14 (LC). In an embodiment, the display device 1 may further include a light source module (not shown), an upper/lower polarizer (not shown), or a driving element (not shown, which may include a circuit element such as a driving chip, a flexible circuit board, or a printed circuit board), but the disclosure is not limited thereto. The light source module may be disposed below the active element array substrate 10, so that the active element array substrate 10 is disposed between the liquid crystal layer 14 and the light source module, but the disclosure is not limited thereto. In other embodiments, if the display device 1 is a reflective display device or a transparent display device, no light source module is required, or a light source module may be disposed in another position not below the active element array substrate 10.

As shown in FIG. 1, the active element array substrate 10 may include a substrate 100, a light shielding layer 101, a buffer layer 102, a semiconductor layer 103, an insulation layer 104, a first conductive layer 105, an insulation layer 106, a second conductive layer 107, an insulation layer 108, a third conductive layer 109, an insulation layer 110, and a fourth conductive layer 111, but the disclosure is not limited thereto.

The substrate 100 is adapted to carry an element. A material of the substrate 100 may include glass, plastic, resin, or a combination of the above, but the disclosure is not limited thereto. A patterned light shielding layer 101 is disposed on the substrate 100, for shielding irradiation of the light source module or ambient light on a channel region CH of the semiconductor layer 103 of the active element, so as to reduce generation of a light leakage current. A material of the light shielding layer 101 may include a non-light-transmitting material, a light-absorbing material, a light-reflecting material or a combination of the above, for example, a metallic material, a semiconductor material, a resin material, an organic insulating material, an inorganic insulating material, or a combination of the above, which is formed by single-layer or multilayer stack, but the disclosure is not limited thereto. The light shielding layer 101 may include a plurality of light shield patterns 1010, and light may pass between the light shield patterns 1010. In other embodiments, other insulation layers may be included between the light shielding layer 101 and the substrate 100.

The buffer layer 102 is disposed on the light shielding layer 101 and the substrate 100. A material of the buffer layer 102 may include SiNx, SiOx, SiOxNy, an organic insulating material, an inorganic insulating material, or a combination of the above, but the disclosure is not limited thereto. The semiconductor layer 103 is disposed on the buffer layer 102. A material of the semiconductor layer 103 may include an amorphous silicon layer, a poly silicon material, or an oxide semiconductor material (e.g., IGZO), but the disclosure is not limited thereto. The semiconductor layer 103 may include one or more semiconductor patterns 1030 corresponding to the active elements respectively. Each of the semiconductor patterns 1030 may include a plurality of channel regions CH and a plurality of doped regions (e.g., a doped region DP1, a doped region DP3, and a doped region DP5), and the plurality of channel regions CH may completely or at least partially overlap with the plurality of light shield patterns 1010.

The insulation layer 104 is disposed on the semiconductor layer 103 and the buffer layer 102 and covers the semiconductor layer 103 and the buffer layer 102. The insulation layer 104 may also be referred to as a gate insulation layer. A material of the insulation layer 104 may include SiNx, SiOx, SiOxNy, an organic insulating material, an inorganic insulating material, or a combination of the above, but the disclosure is not limited thereto. The first conductive layer 105 is disposed on the insulation layer 104. A material of the first conductive layer 105 may include metal (such as copper, aluminum, silver, gold, molybdenum, and titanium), an alloy, a conductive metal oxide (e.g., ITO), or a combination of the above, but the disclosure is not limited thereto.

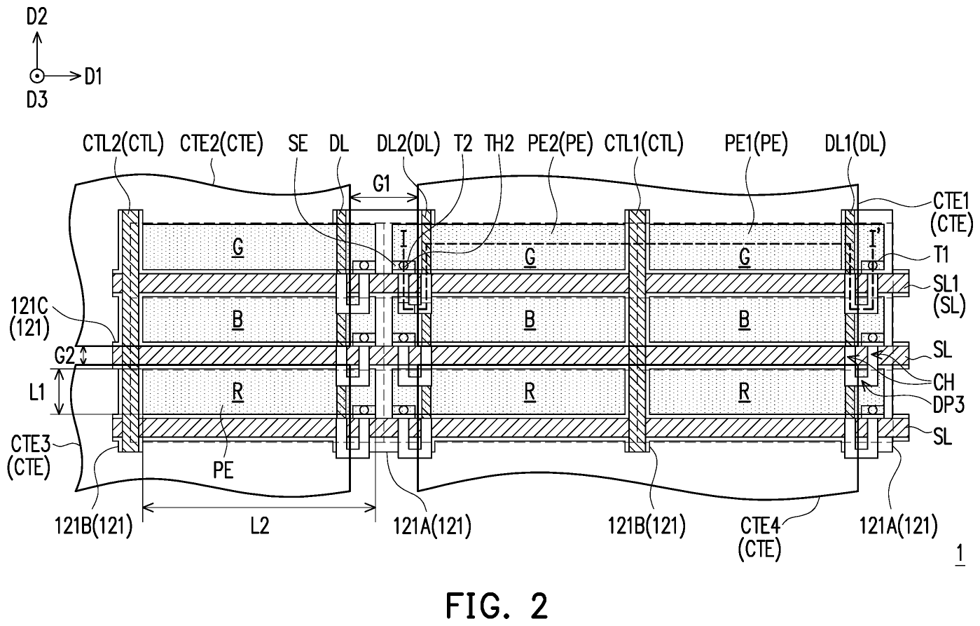

The first conductive layer 105 may include a plurality of scan lines SL (not shown in FIG. 1; please refer to FIG. 2) and a plurality of gates GE, but the disclosure is not limited thereto. In other embodiments, the first conductive layer 105 may also include a common electrode line, a capacitance electrode, or other wires or electrodes. In other embodiments, the plurality of scan lines SL and the plurality of gates GE may be formed by the same layer, and are physically connected and electrically connected. The gates GE may be a part of the scan lines SL. The gates GE correspond to the channel regions CH of the semiconductor layer 103 in the thickness direction D3 to control conduction characteristics of the channel regions CH.

The insulation layer 106 is disposed on the first conductive layer 105 and the insulation layer 104 and covers the first conductive layer 105 and the insulation layer 104. A material of the insulation layer 106 may include SiNx, SiOx, SiOxNy, an organic insulating material, an inorganic insulating material, or a combination of the above, but the disclosure is not limited thereto. The second conductive layer 107 is disposed on the insulation layer 106.

The material of the second conductive layer 107 may include metal, an alloy, a conductive metal oxide, or a combination of the above, but the disclosure is not limited thereto. The second conductive layer 107 may include a plurality of sources SE, a plurality of drains DE, a plurality of data lines (e.g., the first data line DL1 and the second data line DL2), and a plurality of signal lines (e.g., the first signal line CTL1), but the disclosure is not limited thereto. In other embodiments, the second conductive layer 107 may also include a common electrode line, a capacitance electrode, or other wires or electrodes. In the embodiment, the plurality of sources SE, the plurality of drains DE, the plurality of data lines (e.g., the first data line DL1 and the second data line DL2), and the plurality of signal lines may be formed by the same layer, the sources SE (or the drains DE) are physically connected and electrically connected to either of the first data line DL1 and the second data line DL2, and the sources SE (or the drains DE) may be a part of the first data line DL1 or the second data line DL2. The insulation layer 104 and the insulation layer 106 may be provided with through holes TH1. Each of the sources SE may be electrically connected to the corresponding semiconductor pattern 1030 through the corresponding through hole TH1, and each of the drains DE may be electrically connected to the corresponding semiconductor pattern 1030 through the corresponding through hole TH1. In an embodiment, the sources SE and the drains DE are interchangeable.

The insulation layer 108 is disposed on the second conductive layer 107 and the insulation layer 106 and covers the second conductive layer 107 and the insulation layer 106. A material of the insulation layer 108 may include an organic insulating material, an inorganic insulating material (such as SiNx, SiOx, or SiOxNy), or a combination of the above, but the disclosure is not limited thereto. The third conductive layer 109 is disposed on the insulation layer 108.

The material of the third conductive layer 109 may include a light-transmitting conductive material (e.g., ITO), a metal mesh, a silver nanowire, a metal alloy, or a combination of the above, but the disclosure is not limited thereto. The third conductive layer 109 may include a plurality of functional electrodes (e.g., the first functional electrode CTE1). The functional electrodes may be used as a common electrode in a display mode, and the functional electrodes may be used as a part of a sensing electrode or a touch electrode in a touch mode. The insulation layer 108 may be provided with through holes TH2. The functional electrodes (e.g., the first functional electrode CTE1) may be electrically connected to the corresponding signal lines (e.g., the first signal line CTL1) through the corresponding through holes TH2. The first signal line CTL1 may be used as a signal line for transmitting a touch signal, or transmitting at least a part of a touch signal.

The insulation layer 110 is disposed on the third conductive layer 109 and the insulation layer 108 and covers the third conductive layer 109 and the insulation layer 108, and a part of the insulation layer 110 may extend into a part of the through holes TH2. The insulation layer 110 includes through holes TH3 corresponding to the through holes TH2. A material of the insulation layer 110 may include an organic insulating material, an inorganic insulating material (such as SiNx, SiOx, or SiOxNy), or a combination of the above, but the disclosure is not limited thereto.

The fourth conductive layer 111 is disposed on the insulation layer 110. A material of the fourth conductive layer 111 may include a light-transmitting conductive material (e.g., ITO), a metal mesh, a silver nanowire, a metal alloy, or a combination of the above, but the disclosure is not limited thereto. The fourth conductive layer 111 may include a plurality of pixel electrodes (e.g., the first pixel electrode PE1 and the second pixel electrode PE2), but the disclosure is not limited thereto. Each of the pixel electrodes (e.g., the first pixel electrode PE1 or the second pixel electrode PE2) may be electrically connected to the corresponding drain DE (or the source SE) through the corresponding through hole TH3 and the corresponding through hole TH2.

It should be noted that quantities, sizes, shapes of the films and/or the elements in the active element array substrate 10 and a relative configuration relationship between the films may vary according to requirements, but are not limited to those shown above or in FIG. 1. In an embodiment, the active element array substrate 10 may further include other films and/or other elements.

The opposite substrate 12 overlaps with the active element array substrate 10 in the thickness direction D3 (normal direction) of the display device 1. The opposite substrate 12 may include a substrate 120, a shielding layer 121, and a color conversion layer 122, but the disclosure is not limited thereto.

The substrate 120 may be suitable for carrying an element. The material of the substrate 120 may include glass, plastic, resin, or a combination of the above, but the disclosure is not limited thereto. The shielding layer 121 is disposed on a surface of the substrate 120 facing the active element array substrate 10. The shielding layer 121 may be a BM or other appropriate material used as a shielding layer. The shielding layer 121 is adapted to shield elements below it, for example, active elements, metal wires, metal electrodes, or other elements that require shielding light illumination or reflection. In other words, the shielding layer 121 at least overlaps with the active elements in the thickness direction D3 (normal direction) of the display device 1. A material of the shielding layer 121 may include a non-light-transmitting material, a light-absorbing material, resin, metal, a multi-layer film, or a combination of the above, but the disclosure is not limited thereto. The shielding layer 121 includes a plurality of openings O that may allow light to pass through. The openings overlap with the plurality of pixel electrodes (e.g., the first pixel electrode PE1 and the second pixel electrode PE2) in the active element array substrate 10 in the thickness direction D3 (normal direction) of the display device 1.

The color conversion layer 122 is also disposed on the surface of the substrate 120 facing the active element array substrate 10. The color conversion layer 122 may include a plurality of color conversion layers (e.g., the first color conversion layer CL1 and the second color conversion layer CL2). The color conversion layer 122 may include a color filter, a quantum dot material, a fluorescence material, or a phosphor material. The plurality of color conversion layers are disposed in the plurality of openings O respectively, and the plurality of color conversion layers may include a plurality of red color conversion layers, a plurality of green color conversion layers, and a plurality of blue color conversion layers, but are not limited thereto. In the embodiment, the first color conversion layer CL1 and the second color conversion layer CL2 may both be red color conversion layers, both be green color conversion layers, or both be blue color conversion layers. Correspondingly, colors (i.e., a first color) of the first light LT1 and the second light lT2 may both be red, both be green, or both be blue. In the embodiment, the first color conversion layer CL1 and the second color conversion layer CL2 in a first direction D1 may be in the same color. In other embodiments, the first color conversion layer CL1 and the second color conversion layer CL2 in the first direction D1 may be in different colors.

It should be noted that quantities, sizes, shapes of the films and/or the elements in the opposite substrate 12 and a relative configuration relationship between the films may vary according to requirements, but are not limited to those shown above or in FIG. 1. In an embodiment, the opposite substrate 12 may further include other films (e.g., conductive layers) and/or other elements.

The liquid crystal layer 14 is disposed between the active element array substrate 10 and the opposite substrate 12. A plurality of liquid crystal molecules (not shown) in the liquid crystal layer 14 change directions according to an electric field between the active element array substrate 10 and the opposite substrate 12, thereby controlling polarization of the light, and a polarizer is coordinated to control strength (grayscale) of output light. Types of the plurality of liquid crystal molecules in the liquid crystal layer 14 are not limited. For example, the liquid crystal molecules may be twist nematic (TN) liquid crystal molecules, vertical alignment (VA) liquid crystal molecules, in-plane switching (IPS) liquid crystal molecules, or fringe field switching (FFS) liquid crystal molecules, but are not limited thereto. In the embodiment, FFS liquid crystals are taken as an example.

In the embodiment, as seen from the thickness direction D3 (normal direction) of the display device 1, the first signal line CTL1 is disposed between two adjacent pixel electrodes (e.g., the first pixel electrode PE1 and the second pixel electrode PE2). Therefore, the first signal line CTL1 may be shielded by the shielding layer 121 between the first color conversion layer CL1 and the second color conversion layer CL2. If the first signal line CTL1 is disposed near the first data line DL1 (or the second data line DL2), a proper distance should be kept between the first signal line CTL1 and the adjacent first data line DL1 (or the second data line DL2) to prevent a short circuit. In this way, an active element T and the first signal line CTL1 can be shielded only by expanding an area of the shielding layer 121 disposed above the active element T, which leads to a significant decrease in the aperture ratio. In contrast, an extent of reduction of the openings O of the shielding layer 121 is reduced by shielding the first signal line CTL1 by the shielding layer 121 between the first color conversion layer CL1 and the second color conversion layer CL2, thus improving the problem of reduction of the aperture ratio. In addition, required process steps and the number of masks can be reduced by making the first data line DL1, the second data line DL2, and the first signal line CTL1 formed by the same layer, thus helping to reduce the cost.

FIG. 2 is a schematic partial top view of the display device 1 according to the first embodiment of the disclosure. A profile I-I′ corresponding to the cross-sectional view of FIG. 1 is marked in FIG. 2. Referring to FIG. 2, the display device 1 may include a plurality of sub-pixels, for example, a plurality of red sub-pixels R, a plurality of green sub-pixels G, and a plurality of blue sub-pixels B (boundaries of the sub-pixels are marked with dotted lines in FIG. 2). The red sub-pixels R are disposed corresponding to the red color conversion layers and output red light. The green sub-pixels G are disposed corresponding to the green color conversion layers and output green light. The blue sub-pixels B are disposed corresponding to the blue color conversion layers and output blue light.

As shown in FIG. 2, a plurality of sub-pixels in the same color may be arranged along the first direction D1, and the red sub-pixels R, the blue sub-pixels B, and the green sub-pixels G may be sequentially arranged along a second direction D2, but the disclosure is not limited thereto. For example, the red sub-pixels R, the green sub-pixels G, and the blue sub-pixels B may be sequentially arranged along the second direction D2.

As shown in FIG. 2, in the embodiment, the scan lines SL substantially extend along the first direction D1, the data lines DL substantially extend along the second direction D2, and an angle between the scan lines SL and the data lines DL may be 90 degrees orthogonal. In other embodiments, the scan lines SL may be non-linear or may not extend along the first direction D1, or the data lines DL may be non-linear or may not extend along the second direction D2. The angle between the two may not be 90 degrees. Each of the scan lines SL may be disposed corresponding to pixel electrodes PE of a plurality of sub-pixels in the same color arranged along the first direction D1. For example, a first scan line SL1 may correspond to the first pixel electrode PE1 and the second pixel electrode PE2, but the disclosure is not limited thereto. In addition, each of the pixel electrodes PE (including the first pixel electrode PE1 and the second pixel electrode PE2) includes a first length L1 in a direction (e.g., the second direction D2) parallel to the data line DL extension direction (e.g., the first data line DL1) and includes a second length L2 in a direction (e.g., the first direction D1) in a direction perpendicular to the data line DL extension direction (e.g., the first data line DL1), where the first length L1 is less than the second length L2. In an embodiment, the first length L1 and the second length L2 are maximum lengths of the pixel electrodes PE in the direction respectively. In another embodiment, long sides of the pixel electrodes PE may be substantially parallel to the scan lines SL, and short sides of the pixel electrodes PE may be substantially parallel to the data lines DL. In the design, the shielding layer 121 overlapping with signal lines CTL may be on the short sides of the pixel electrodes PE, which can thus effectively reduce influences of expansion of the area of the shielding layer on the aperture ratio.

As shown in FIG. 2, the shielding layer 121 may include a plurality of first portions (hereinafter referred to as first shielding layers 121A) extending along the second direction D2 and disposed corresponding to the data lines DL (e.g., the first data line DL1), a plurality of second portions (hereinafter referred to as second shielding layers 121B) extending along the second direction D2 and disposed corresponding to the signal lines CTL (e.g., the first signal line CTL1), and a plurality of third portions (hereinafter referred to as third shielding layers 121C) extending along the first direction D1 and disposed corresponding to the scan lines SL (e.g., the first scan line SL). The shielding layer 121 may be regarded as a group of the first shielding layers 121A, the second shielding layers 121B, and the third shielding layers 121C, forming a network structure.

In addition to the first functional electrode CTE1, the display device 1 may further include a plurality of functional electrodes CTE, which may also be used as touch sensing electrodes. FIG. 2 schematically marks the first functional electrode CTE1 to fourth functional electrode CTE4, but the number of the plurality of functional electrodes CTE are not limited thereto. In the embodiment, the second functional electrode CTE2 is spacing apart from the first functional electrode CTE1 by a gap G1, and the gap G1 overlaps with the first shielding layer 121A. Similarly, the third second functional electrode CTE3 is spacing apart from the fourth functional electrode CTE4 also by a gap G1, and the gap G1 spacing apart the third second functional electrode CTE3 from the fourth functional electrode CTE4 also overlaps with the first shielding layer 121A. On the other hand, the second functional electrode CTE2 is spacing apart from the third functional electrode CTE3 by a gap G2, and the gap G2 overlaps with the third shielding layer 121C. Similarly, the first functional electrode CTE1 is separated from the fourth functional electrode CTE4 also by a gap G2, and the gap G2 spacing apart the first functional electrode CTE1 from the fourth functional electrode CTE4 also overlaps with the third shielding layer 121C.

When the functional electrodes are separated by the gap G1 and/or the gap G2, a short circuit between two adjacent functional electrodes can be prevented. In addition, influences of an electric field between two adjacent functional electrodes on a display medium (e.g., the liquid crystal molecules) can be reduced through the gap between the two adjacent functional electrodes, thus helping to improve display quality.

It should be noted that a shape and a size of each of the functional electrodes and a relative disposing relationship between the plurality of functional electrodes may vary according to requirements, but are not limited to those shown in FIG. 2. The functional electrodes may be in a shape of a rectangle, a rhombus, a parallelogram, a mesh, and so on. A width of the functional electrodes in the first direction D1 or in the second direction D2 may cover one, two, three, four, or more sub-pixels without limitations. The functional electrodes may be connected into a horizontal row along the first direction D1 and be arranged at intervals in the second direction D2, or the functional electrodes may also be connected into a straight row along the second direction D2 and be arranged at intervals in the first direction D1.

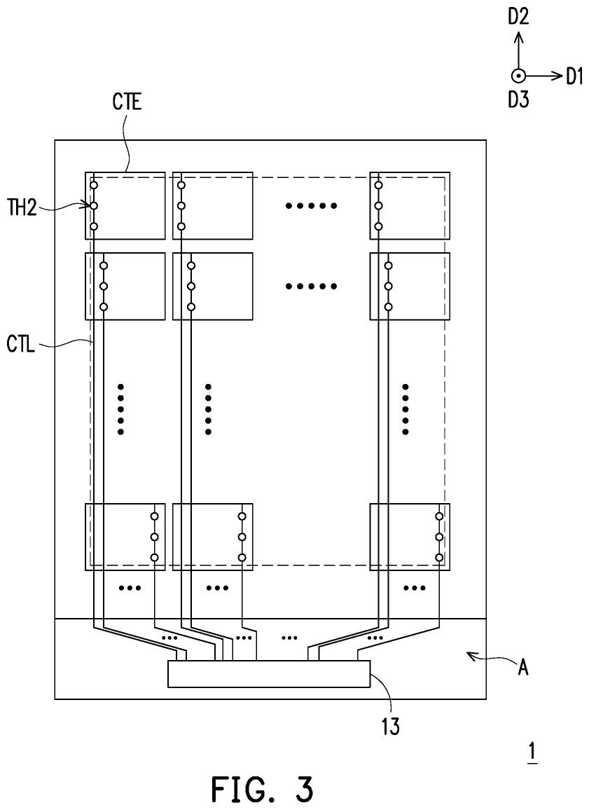

FIG. 3 is a schematic top view of a signal line CTL and a functional electrode CTE in the display device 1 according to the disclosure. Referring to FIG. 3, the display device 1 may include a plurality of signal lines CTL and a plurality of functional electrodes CTE. The plurality of functional electrodes CTE may be arranged into an array, and each of the functional electrode CTE may overlap with a plurality of sub-pixels in the thickness direction D3 (normal direction) of the display device 1.

Each of the functional electrode CTE may be electrically connected to the corresponding signal line CTL through at least one through hole TH2. FIG. 3 schematically shows that each of the functional electrode CTE is electrically connected to the corresponding signal line CTL through three through holes TH2, but a quantity of through holes and/or a quantity of signal lines CTL corresponding to each of the functional electrode CTE may vary according to requirements and are not limited thereto.

According to different requirements, the display device 1 may further include other elements and/or films. For example, the display device 1 may further include a driving circuit 13. The driving circuit 13 may be disposed in an outer pin joint region A and electrically connected to a plurality of signal lines CTL.

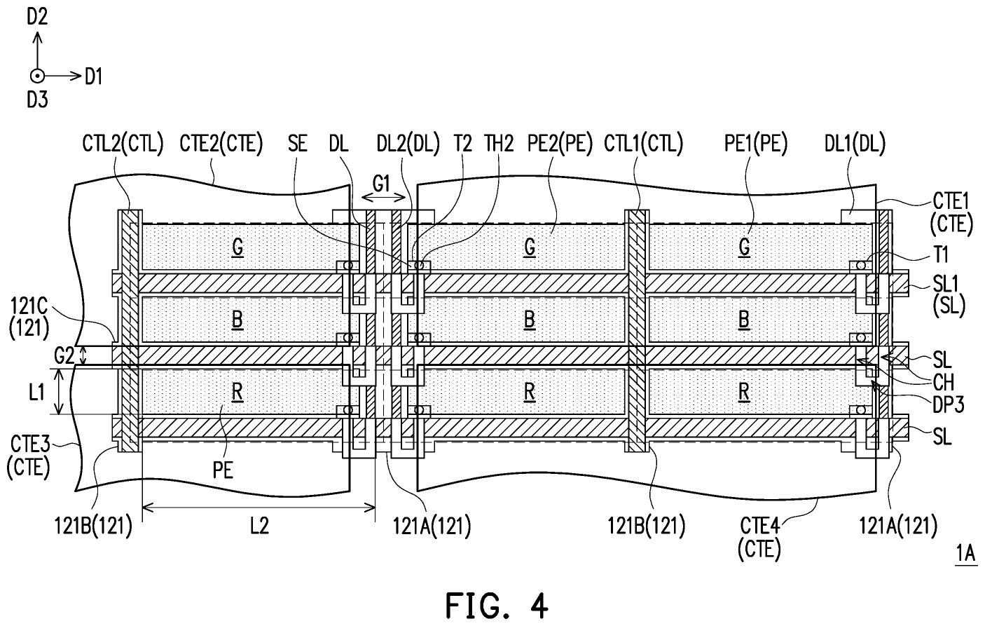

FIG. 4 to FIG. 6 are schematic partial top views of a display device 1A according to a second embodiment of the disclosure to a display device 1C according to a fourth embodiment respectively. Referring to FIG. 4, main differences between the display device 1A and the display device 1 of FIG. 2 are described as follows. In the display device 1 of FIG. 2, two active elements T of two adjacent sub-pixels (e.g., two adjacent red sub-pixels R, two adjacent green sub-pixels G, or two adjacent blue sub-pixels B) between two adjacent signal lines CTL are disposed between two data lines DL electrically connected to the two adjacent sub-pixels. On the other hand, in the display device 1A, the two data lines DL electrically connected to the two adjacent sub-pixels (e.g., two adjacent red sub-pixels R, two adjacent green sub-pixels G, or two adjacent blue sub-pixels B) between the two adjacent signal lines CTL, and the two data lines DL are disposed between the two active elements T of the two adjacent sub-pixels.

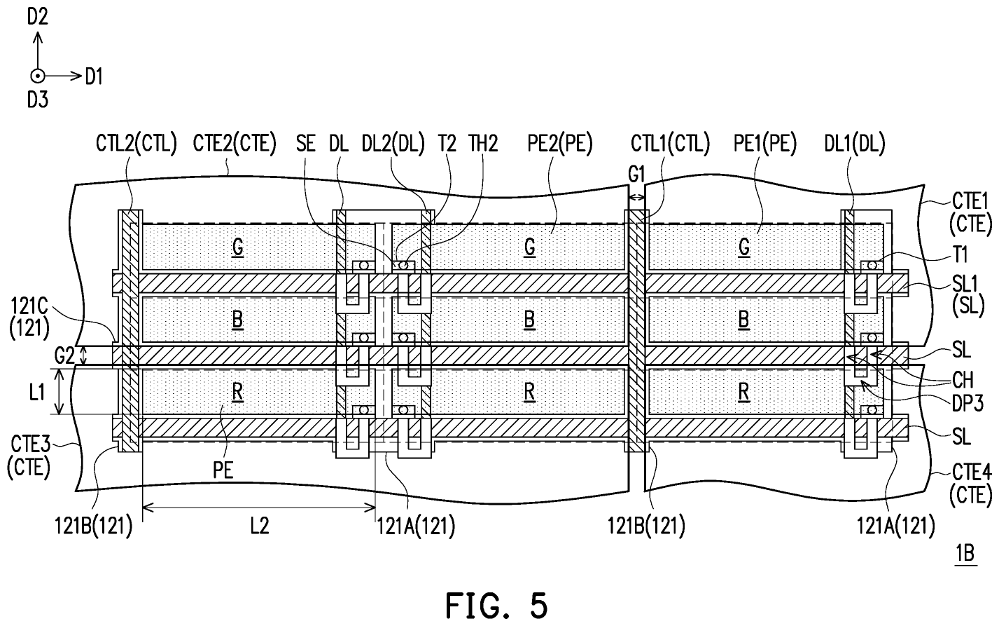

Referring to FIG. 5, the main differences between the display device 1B and the display device 1 of FIG. 2 are described as follows. In the display device 1B, a gap G1 spacing apart the second functional electrode CTE2 from the first functional electrode CTE1 overlaps with the second shielding layer 121B. Similarly, a gap G1 spacing apart the third functional electrode CTE3 from the fourth functional electrode CTE4 also overlaps with the second shielding layer 121B.

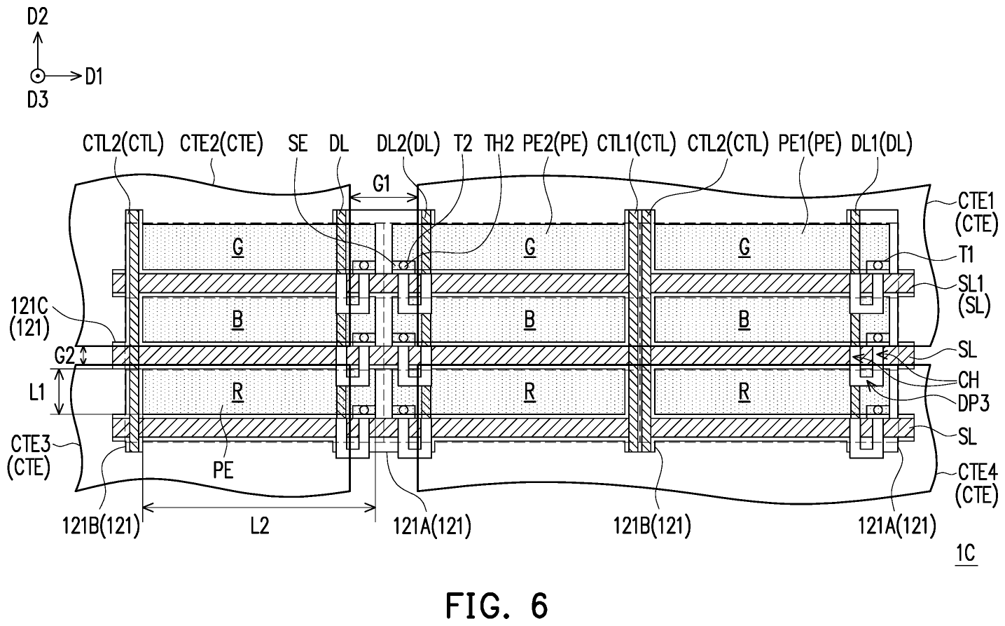

Referring to FIG. 6, main differences between the display device 1C and the display device 1 of FIG. 2 are described as follows. The display device 1C further includes a second signal line CTL2. As seen from a thickness direction D3 (normal direction) of the display device 1C, the second signal line CTL2 is also disposed between the first pixel electrode PE1 and the second pixel electrode PE2. In other words, the first signal line CTL1 and the second signal line CTL2 are disposed between the first pixel electrode PE1 and the second pixel electrode PE2.

The second signal line CTL2 and the first signal line CTL1 may be disposed on the same layer. In addition, the first signal line CTL1 and the second signal line CTL2 may be electrically connected to the same or different functional electrodes CTE. In an embodiment, the second signal line CTL2 may be a dummy signal line, that is to say, the second signal line CTL2 may not be connected to any functional electrode and the second signal line CTL2 is used for capacitance matching. In an embodiment, a quantity of signal lines disposed between two adjacent pixel electrodes may vary.

By increasing the quantity of the signal lines disposed between the two adjacent pixel electrodes, a quantity (density per unit area) of the functional electrodes CTE may also be increased accordingly, thus helping to improve touch accuracy.

Based on the above, in the embodiments of the disclosure, the problem of reduction of the aperture ratio can be alleviated by disposing the first signal line between the first pixel electrode and the second pixel electrode. In an embodiment, the first data line, the second data line, and the first signal line may be formed by the same layer, so as to reduce the cost. In an embodiment, influences of expansion of the area of the shielding layer on the aperture ratio can be effectively reduced by designing the long sides of the pixel electrodes to be parallel to the scan lines and the short sides to be parallel to the data lines. In an embodiment, influences of an electric field between the functional electrodes on a display medium can be reduced by designing a gap between the functional electrodes to overlap with the shielding layers overlapping with the data lines, thereby improving display quality. In an embodiment, the gap between the functional electrodes may also overlap with the shielding layers overlapping with the signal lines. In an embodiment, touch accuracy can be improved by increasing a quantity of the signals lines and a quantity of the functional electrodes disposed between two adjacent pixel electrodes.

The above embodiments are provided merely for describing the technical solutions of the disclosure, but are not intended to limit the disclosure. It should be understood by a person of ordinary skill in the art that although the disclosure has been described in detail with reference to the above embodiments, modifications can be made to the technical solutions described in the above embodiments, or equivalent replacements can be made to some or all technical features in the technical solutions, as long as such modifications or replacements do not cause the essence of corresponding technical solutions to depart from the scope of the technical solutions of the embodiments of the disclosure.

Although the embodiments and advantages of the disclosure have been disclosed above, it should be understood that, a person of ordinary skill in the art may make variations, replacements and modifications without departing from the spirit and scope of the disclosure, and that features between the embodiments can be arbitrarily intermixed and replaced to form other new embodiments. In addition, the protection scope of the disclosure is not limited to a process, machine, manufacturing, material composition, device, method, and step in a specific embodiment in this specification. A person of ordinary skill in the art may understand the existing or to-be-developed process, machine, manufacturing, material composition, device, method, and step from the content of the disclosure, which may be used according to the disclosure as long as the substantially same function can be implemented or the substantially same result can be obtained in the embodiments described herein. Therefore, the protection scope of the disclosure includes the foregoing process, machine, manufacturing, material composition, device, method, and step. In addition, each claim forms an independent embodiment, and the protection scope of the disclosure also includes a combination of claims and embodiments. The protection scope of the disclosure should be subject to the appended claims.

What is claimed is:

1. A display device, comprising:
a first data line;
a second data line;
a first pixel electrode electrically connected to the first data line, the first pixel electrode corresponding to a first color;
a second pixel electrode electrically connected to the second data line, the second pixel electrode corresponding to the first color;
a first signal line disposed between the first pixel electrode and the second pixel electrode; and
a first functional electrode electrically connected to the first signal line.

2. The display device according to claim 1, further comprising:
a scan line corresponding to the first pixel electrode and the second pixel electrode.

3. The display device according to claim 1, wherein the first pixel electrode has a first length in a direction parallel to the first data line and a second length in a direction perpendicular to the first data line, wherein the first length is less than the second length.

4. The display device according to claim 1, wherein the first data line, the second data line, and the first signal line are formed by the same layer.

5. The display device according to claim 1, further comprising:
a second signal line disposed between the first pixel electrode and the second pixel electrode; and
a second functional electrode electrically connected to the second signal line.

6. The display device according to claim 1, further comprising:
a first shielding layer disposed corresponding to the first data line; and
a second functional electrode spacing apart from the first functional electrode by a gap, wherein the gap overlaps with the first shielding layer.

7. The display device according to claim 1, further comprising:
a second shielding layer disposed corresponding to the first signal line; and
a second functional electrode spacing apart from the first functional electrode by a gap, wherein the gap overlaps with the second shielding layer.

8. A touch display device, comprising:
a first data line and a second data line;
a first pixel electrode electrically connected to the first data line;
a second pixel electrode electrically connected to the second data line, the second pixel electrode being adjacent to the first pixel electrode, and a gap being provided between the first pixel electrode and the second pixel electrode;
a signal line disposed corresponding to the gap; and
a functional electrode electrically connected to the signal line.

9. The touch display device according to claim 8, wherein the signal line is in the same layer as the first data line or the second data line.

10. The touch display device according to claim 8, wherein the functional electrode at least partially overlaps with the first pixel electrode or the second pixel electrode.

11. The touch display device according to claim 10, wherein the functional electrode at least partially overlaps with the first pixel electrode and the second pixel electrode.

12. The touch display device according to claim 10, wherein the functional electrode at least partially overlaps with the signal line.

13. The touch display device according to claim 8, further comprising:
a first color conversion layer disposed corresponding to the first pixel electrode; and
a second color conversion layer disposed corresponding to the second pixel electrode.

14. The touch display device according to claim 13, wherein a color of a light emitted by a light source after passing through the first color conversion layer is the same as that of another light emitted by the light source after passing through the second color conversion layer.

15. The touch display device according to claim 13, wherein a color of a light emitted by a light source after passing through the first color conversion layer is different from that of another light emitted by the light source after passing through the second color conversion layer.

16. The touch display device according to claim 13, further comprising:
a light shielding layer disposed between the first color conversion layer and the second color conversion layer, and the light shielding layer being disposed corresponding to the gap.

17. The touch display device according to claim 8, wherein in a display period, the functional electrode is used as a common electrode, and in a touch period, the functional electrode is used as a sensing electrode.

18. The touch display device according to claim 8, wherein in a display period, the signal line transmits a common signal, and in a touch period, the signal line transmits a sensing signal.

19. The touch display device according to claim 8, further comprising:
an insulation layer disposed between the first pixel electrode and the functional electrode, or disposed between the second pixel electrode and the functional electrode.

20. The touch display device according to claim 8, further comprising:
a first active element, the first pixel electrode being electrically connected to the first data line through the first active element; and
a second active element, the second pixel electrode being electrically connected to the second data line through the second active element, and the signal line being disposed between the first active element and the second active element.
